(19) United States
(12) Patent Application Publication
(10) Pub. No.: US 2025/0215619 A1
(43) Pub. Date: Jul. 3, 2025

(54) CARBON FIBER WITH IMPROVED TENSILE PROPERTIES FORMED FROM PAN-BASED FIBER WITH CERTAIN CHEMICAL SIGNATURE

(71) Applicant: Hexcel Corporation, San Ramon, CA (US)

(72) Inventors: Andrew May, Decatur, AL (US); Anna Walter, Decatur, AL (US); Jacob Mayers, Decatur, AL (US); Michael Yurchenko, Decatur, AL (US); Cary Martin, Decatur, AL (US)

(21) Appl. No.: 18/990,050

(22) Filed: Dec. 20, 2024

Related U.S. Application Data
(60) Provisional application No. 63/616,064, filed on Dec. 29, 2023.

(51) Int. Cl. D01F 9/22; C08F 220/46; D01F 6/38

(52) U.S. Cl. CPC D01F 9/22; C08F 220/46; D01F 6/38; C08F 2800/20; D10B 2401/063; D10B 2505/02

(57) ABSTRACT

The invention is directed to carbon fibers prepared from polyacrylonitrile (PAN) dopes aged at low temperatures. The PAN dopes are aged at low temperatures to facilitate the formation of certain structures in the PAN polymer. When the PAN comprising these structures is formed into carbon fibers, these fibers have improved tensile properties. Alternative methods of introducing the certain structures into PAN fibers are also provided for by the invention.

### CROSS-REFERENCE TO RELATED APPLICATIONS

This application claims the benefit of and priority to U.S. Provisional Patent Application No. 63/616,064, filed Dec. 29, 2023, which is herein incorporated by reference in its entirety for all purposes.

### FIELD OF THE INVENTION

The present invention relates generally to carbon fibers prepared from polyacrylonitrile fibers containing certain chemical functionalities.

### BACKGROUND OF THE INVENTION

Carbon fibers have been used in a wide variety of structural applications and industries because of their desirable properties. For example, carbon fibers can be formed into a structural component that combines high strength and high stiffness, while having a weight that is significantly lighter than a metal component of equivalent properties. Carbon fibers can be manufactured by converting a precursor fiber, such as a spun polyacrylonitrile (PAN) fiber, in a multi-step process in which the precursor fiber is heated, oxidized, and carbonized to produce a fiber that is 90% or greater carbon. The resulting carbon fibers can be molded into high strength composite materials for structural applications, used in their pure form for electrical and friction applications, or can be further processed for use in adsorbent, filter, or other applications. In particular, composite materials have been developed in which carbon fibers serve as a reinforcing material in a resin, ceramic, or metal matrix.

Current trends in automotive, aerospace, structural, and other applications have continued a push for materials with ever-higher tensile strengths and modulus. Polyacrylonitrile-based carbon fiber has become a leading reinforcement in composites, both thermosets and thermoplastics, that satisfy this basic need. They have enabled current generations of ground and air transportation and structures that are more fuel-efficient than their predecessors due to weight reduction and other efficiencies.

However, there is still a need for even stronger and stiffer materials to enable further efficiency improvements. Higher strength and modulus allow for a resulting composite that can achieve the same strength at even lighter weights than current state-of-the-art technology, achieving a more fuel-efficient plane or car. Being able to make a stronger fiber, preferably without changing other properties of the material (e.g., cost, density) would allow for a pareto improvement in design of these structures.

Thus, there exists a need for carbon fibers having improved tensile strength, and compositions, copolymers, and methods for producing such fibers.

### BRIEF SUMMARY OF THE INVENTION

The present invention provides a polyacrylonitrile (PAN)-based precursor carbon fiber, said precursor carbon fiber having a total aging integration ratio (TAIR) of from about 0.0005 to about 0.1000, wherein TAIR is equal to

(X+Y)/Z
wherein X is the integrated peak area in a range of 11.0-10.5 ppm, Y is the integrated peak area in a range of 8.0-6.5 ppm, and Z is the integrated peak area in a range of 1.83-2.25 ppm, according to 1H-NMR in deuterated DMSO.

Another embodiment of the invention is a carbon fiber prepared from a PAN-based precursor carbon fiber described herein, wherein the prepared carbon fiber has an ultimate tensile strength (UTS) of greater than about 5500 MPa.

Another embodiment of the invention is a a fiber-reinforced composite laminate comprising a carbon fiber as described herein.

Thus, the invention provides carbon fibers having improved tensile strength, and composites comprising such fibers, and compositions, copolymers, and methods for producing such fibers.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A shows commonly accepted polyacrylonitrile cyclization, tautomerization, stabilization, and oxidation mechanisms.

FIG. 1B shows proposed chemical structures within aged PAN copolymer;

FIG. 2 shows a proposed mechanism for generation of the chemical structures in FIG. 1B.

FIG. 3 shows an increase in absorbance at 1670 cm⁻¹, representing an increase in Extent of Aging (EoA).

FIG. 4A shows ¹H-NMR of acid-washed dope aged film in d-DMSO. FIGS. 4B-4C show the peaks used to calculate TAIR.

FIG. 5A shows a plot of EoA vs. time for varying aging temperatures. FIG. 5B shows the correlation between rate of aging and aging temperature.

FIGS. 6A-6B show the correlation between EoA and UTS for batch and continuous aging schemes, respectively.

FIG. 7 shows partial ¹H-NMR (DMSO-d6) spectrum of model compounds 1 and 2.

FIG. 8 shows ¹H-NMR spectrum of model compound 1 before (top) and after (bottom) 130° C. exposure.

FIG. 9 shows ¹H-NMR (DMSO-d6) spectra of polymer films from aged dope washed with diluted base and deionized water.

FIG. 10 shows an overview of the proposed structures formed during heating of PAN.

FIGS. 11-12 show the correlation between EoA of a polymer film prepared from a dope, the TAIR of the polymer film from the dope, and the UTS of carbon fiber prepared from the dope.

### DETAILED DESCRIPTION OF THE INVENTION

The present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Each embodiment disclosed herein is contemplated as being applicable to each of the other disclosed embodiments. All combinations and sub-combinations of the various elements described herein are within the scope of the embodiments.

In the following description, various components may be identified as having specific values or parameters, however, these items are provided as exemplary embodiments. Indeed, the exemplary embodiments do not limit the various aspects and concepts of the present invention as many comparable parameters, sizes, ranges, and/or values may be implemented. Further, the terms “a,” “an,” and “the” do not denote a limitation of quantity, but rather denote the presence of “at least one” of the referenced item.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 5.1%-9.9%, and 5.01%-9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

All publications, patents and patent applications referred to herein are incorporated by reference in their entirety to the same extent as if each individual publication, patent or patent application was specifically and individually indicated to be incorporated by reference in its entirety, except to the extent that the incorporated material is inconsistent with the express disclosure herein, in which case the language in this disclosure controls.

As used herein, “about” in the context of a numerical value or range means ±10% of the numerical value or range recited or claimed.

As used herein, “dope” (also referred to as a “spinning solution”) refers to a solution prepared by dissolving a PAN-based polymer or copolymer in a solvent. The solvent may be, for example, a water/sodium thiocyanate solution.

An embodiment of the invention is a polyacrylonitrile (PAN)-based precursor carbon fiber, said precursor carbon fiber having a total aging integration ratio (TAIR) of from about 0.0005 to about 0.1000, wherein TAIR is equal to

(X+Y)/Z
wherein X is the integrated peak area in a range of 11.0-10.5 ppm, Y is the integrated peak area in a range of 8.0-6.5 ppm, and Z is the integrated peak area in a range of 1.83-2.25 ppm, according to ¹H-NMR in deuterated DMSO.

In an embodiment, the PAN-based precursor carbon fiber is prepared from a copolymer formed from a composition comprising
i) acrylonitrile monomers; and
ii) acidic comonomers comprising an active hydrogen.

In an embodiment, said composition comprises i) in an amount of 80-99.9 wt %; and ii) in an amount of 0.1-20 wt %. In an embodiment, said composition comprises i) in an amount of at least 81, 82, 83, 84, 85, 86, 87, 88, 89, 90, 91, 92, 93, 94, 95, 96, 97, 98, 99, or 99.5 wt %. In an embodiment, said composition comprises i) in an amount of at most 81, 82, 83, 84, 85, 86, 87, 88, 89, 90, 91, 92, 93, 94, 95, 96, 97, 98, 99, or 99.5 wt %. In an embodiment, said composition comprises ii) in an amount of at least 0.5, 1, 2, 3, 4, 5, 6, 7, 8, 9, 10, 11, 12, 13, 14, 15, 16, 17, 18, or 19 wt %. In an embodiment, said composition comprises ii) in an amount of at most 0.5, 1, 2, 3, 4, 5, 6, 7, 8, 9, 10, 11, 12, 13, 14, 15, 16, 17, 18, or 19 wt %.

In an embodiment, the acidic comonomer comprising an active hydrogen is selected from the group consisting of methacrylic acid, acrylic acid, itaconic acid, and combinations thereof. In an embodiment, the acidic comonomer comprising an active hydrogen is methacrylic acid. In an embodiment, the acidic comonomer comprising an active hydrogen is acrylic acid. In an embodiment, the acidic comonomer comprising an active hydrogen is itaconic acid.

In an embodiment, the composition further comprises iii) at least one monomer or polymer comprising an amide, imide or isoimide functional group, wherein said functional group comprises an active hydrogen.

In an embodiment, the composition comprises iii) in an amount of 0.1-15 wt %. In an embodiment, the composition comprises iii) in an amount of at least about 0.2, 0.5, 1, 2, 3, 4, 5, 6, 7, 8, 9, 10, 11, 12, 13, or 14 wt %. In an embodiment, the composition comprises iii) in an amount of at most about 0.2, 0.5, 1, 2, 3, 4, 5, 6, 7, 8, 9, 10, 11, 12, 13, or 14 wt %.

In an embodiment, the PAN-based precursor carbon fiber is prepared from a copolymer comprising
i) a plurality of units derived from acrylonitrile; and
ii) at least one unit selected from the group consisting of

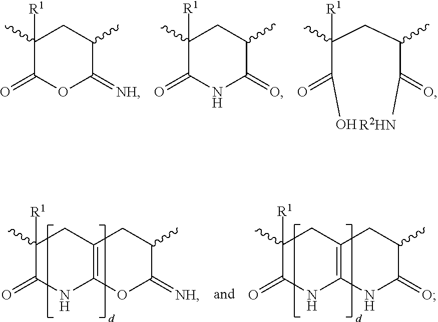

wherein R¹ is —CH₃, —CH₂COOH, or —H;
wherein R² is C₁₋₆ alkyl or —H;
wherein d is 1-1000; and
wherein each [symbol]
represents a point of attachment to the remainder of the copolymer.

In an embodiment, R¹ is —CH₃. In an embodiment, R¹ is —H.

In an embodiment, R² is C₁₋₆ alkyl; In an embodiment, R² is —H;

In an embodiment, the molar ratio of i) to ii) is from 99.9:0.1 to 80:20. In an embodiment, the molar ratio of i) to ii) is about 99.9:0.1; 99.5:05; 99:1; 98:2; 97:3; 96:4; 95:5; 94:6; 93:7; 92:8; 91:9; 90:10; 89:11; 88:12; 87:13; 86:14; 85:15; 84:16; 83:17; 82:18; 81:19; or 80:20, or within a range defined by any two of these values.

In an embodiment, the copolymer is not water soluble at 25° C.

In an embodiment, the TAIR is at least about 0.0006, 0.0007, 0.0008, 0.0009, 0.0010, 0.0011, 0.0012, 0.0013, 0.0014, 0.0015, 0.0016, 0.0017, 0.0018, 0.0019, 0.0020, 0.0021, 0.0022, 0.0023, 0.0024, 0.0025, 0.0026, 0.0027, 0.0028, 0.0029, 0.0030, 0.0031, 0.0032, 0.0033, 0.0034, 0.0035, 0.0036, 0.0037, 0.0038, 0.0039, 0.0040, 0.0041, 0.0042, 0.0043, 0.0044, 0.0045, 0.0046, 0.0047, 0.0048, 0.0049, 0.0050, 0.0055, 0.0060, 0.0065, 0.0070, 0.0075, 0.0080, 0.0085, 0.0090, 0.0095, 0.0100, 0.0150, 0.0200, 0.0250, 0.0300, 0.0350, 0.0400, 0.0450, 0.0500, 0.0550, 0.0600, 0.0650, 0.0700, 0.0750, 0.0800, 0.0850, 0.0900, or 0.0950.

In an embodiment, the TAIR is at most about 0.0050, 0.0055, 0.0060, 0.0065, 0.0070, 0.0075, 0.0080, 0.0085, 0.0090, 0.0095, 0.0100, 0.0150, 0.0200, 0.0250, 0.0300, 0.0350, 0.0400, 0.0450, 0.0500, 0.0550, 0.0600, 0.0650, 0.0700, 0.0750, 0.0800, 0.0850, 0.0900, or 0.0950.

An embodiment is a carbon fiber prepared from a PAN-based precursor carbon fiber described herein, wherein the prepared carbon fiber has an ultimate tensile strength (UTS) of greater than about 5500 MPa. In an embodiment, the UTS is greater than about 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, or 8000.

An embodiment is a fiber-reinforced composite laminate comprising a carbon fiber as described herein.

As discussed in greater detail below, carbon fibers in accordance with the invention can be prepared by subjecting a precursor fiber, such as a fiber comprising polyacrylonitrile (PAN), to an oxidizing atmosphere at elevated temperature. Upon completion of the oxidizing step, the fibers can be advanced through one or more additional furnaces, such as a low temperature furnace and a high temperature furnace, to complete conversion of the precursor fibers into carbon fibers. In the context of the invention the term “fiber” includes a single filament or a plurality of filaments that are bundled together, also referred to as a tow. A tow or bundle may include from about 900 to 100,000 individual filaments.

In the context of the invention, the term “precursor fiber” refers to a fiber comprising a polymeric material that can, upon the application of sufficient heat, be converted into a carbon fiber having a carbon content that is about 90% or greater, and in particular about 95% or greater, by weight. The precursor fiber can comprise both homopolymers and copolymers of acrylonitrile (AN), and may include comonomers such as methyl acrylate (MA), methacrylic acid (MAA), acrylic acid, sodium methallylsulfonate, itaconic acid (IA), vinyl bromide (VB), isobutyl methacrylate (IBMA), and combinations thereof. In one embodiment, the precursor fiber comprises a polyacrylonitrile (PAN) polymer formed primarily from acrylonitrile monomers.

In embodiments, the precursor fibers can be prepared by melt spinning or by solvating the precursor polymers in organic and/or inorganic solvents such as dimethylsulfoxide, dimethyl formamide, zinc chloride or sodium thiocyanate solutions to form a spinning solution (or “dope”). In a particular embodiment, the spinning solution (or “dope”) is formed from water, acrylonitrile polymer and sodium thiocyanate at exemplary respective weight ratios of about 60:10:30. This solution can then be concentrated through evaporation and filtered to provide the dope. In one embodiment, the spinning solution comprises about 15% by weight of the acrylonitrile polymer.

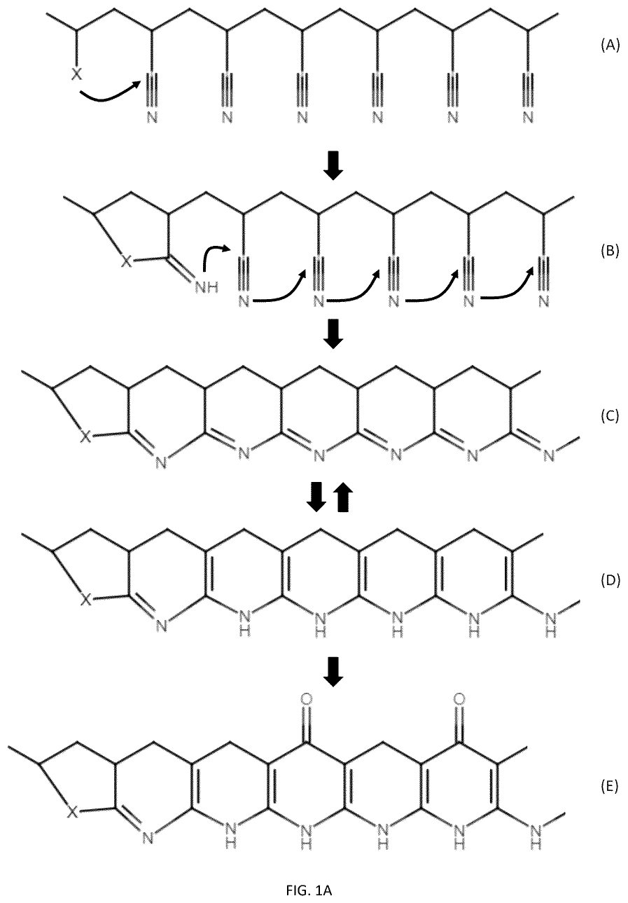

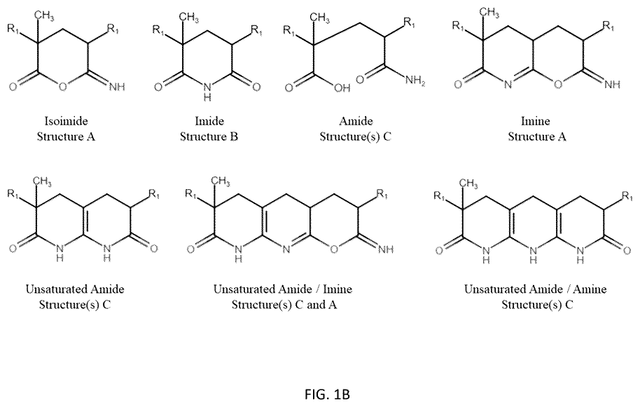

The dope may then be heated in order to facilitate the formation of beneficial structures, such as those shown in FIG. 1B, in the precursor fiber. In certain embodiments, the dope is heated to and/or held at a temperature between 60-150° C. for a period of time. In an embodiment, the temperature is at least, at most, or about 60, 65, 70, 75, 80, 85, 90, 95, 100, 105, 110, 115, 120, 125, 130, 135, 140, 145, or 150° C. The temperature may vary during the time period. This period of time, in an embodiment, is between 1-5000 hours. In an embodiment, the temperature is at least, at most, or about 1, 2, 4, 8, 12, 16, 20, 24, 48, 72, 96, 120, 144, 200, 300, 400, 500, 600, 700, 800, 900, 1000, 1100, 1200, 1300, 1400, 1500, 1600, 1700, 1800, 1900, 2000, 2500, 3000, 3500, 4000, 4500, or 5000 hours. During this time period, the structures shown in FIG. 1B will form in the polymer of the dope.

The dope is then passed through spinnerets using conventional spinning processes, such as dry, dry/wet or wet spinning, to form the polyacrylonitrile precursor. In a particular embodiment, PAN precursor fibers are made using a dry/wet spinning wherein a multitude of filaments are formed from the dope and pass from the spinneret through an air gap or other gap between the spinneret and a bath of coagulant, such as aqueous sodium thiocyanate. After exiting from the coagulant bath, the spun filaments are washed. In some embodiments, the spun filaments can be stretched up to several times their original length in hot water and steam. (See e.g., U.S. Pat. No. 4,452,860, which is incorporated herein by reference.) In addition, the polyacrylonitrile precursor fiber are processed through a finishing stage to improve its handling during manufacture of the carbon fiber. Exemplary methods of preparing PAN precursor fibers are discussed in greater detail in U.S. Pat. Nos. 5,066,433, and 8,591,859, the contents of each of which are incorporated herein by reference.

The precursor fibers can comprise polyacrylonitrile based fibers that are made from between about 80 and 99.9% by weight, and preferably between 85 and 99% by weight acrylonitrile and between about 20 and 0.1%, and preferably between 15 and 1% of other monomers such as methacrylic acid, acrylic acid, methyl acrylate, and methyl methacrylate, and combinations thereof. The polyacrylonitrile precursor fibers are in the form of bundles that each comprise between about 900 and 50,000 filaments per bundle, and in particular between about 3000 and 24,000 filaments per bundle. The filaments may have a mean average denier between about 0.4 and 2, and in particular between about 0.60 and 0.85.

During oxidation, which is also referred to as oxidative stabilization, the PAN precursor fibers are heated in an oxidizing atmosphere at a temperature between about 150° to 600° C. to cause the cyclization and oxidation of the PAN precursor molecules. In this regard, FIG. 1A illustrates in a step-wise manner the commonly accepted process of cyclizing and oxidizing PAN precursor fibers which do not comprise the inventive copolymers and moieties described therein. In step (A), the nitrile groups of the PAN become aligned. X may be any suitable polymerization initiator known in the art. In steps (B) and (C), the nitrile groups polymerize to form a polynaphthyridine ring “ladder” structure, which undergoes tautomerization in step (D) to form a polycyclic dihydropyridine. In step (E), the polycyclic dihydropyridine undergoes oxidation/dehydrogenation to form stabilized pyridone structures. Oxidation and carbonization are discussed in greater detail in U.S. Pat. No. 8,591,859.

### Discussion and Examples

It has been discovered that the presence of a combination of certain chemical groups in PAN-based precursor fiber prior to the carbon fiber manufacturing process, which normally includes processing through oxidation ovens as a first step, allows for manufacturing of carbon fibers with increased tensile strengths (UTS). Authors studied the nature of these groups by ¹H-NMR and FTIR methods, both in actual precursor fibers and polymer films made from dopes. Three distinct NMR signatures were observed in PAN precursor fibers, which were attributed to structures A, B, and C, as shown in FIG. 1B. The rise of these peaks in NMR also correlates to the appearance of FTIR peak in PAN copolymer in a range of 1660-1705 cm⁻¹ (both in fiber and polymer films made from dope).

The appearance of these chemical groups is a result of an initial reaction of a methacrylic acid copolymer present in PAN backbone to the acrylonitrile group and subsequent chemical transformations. These reactions proceeded rather easily at elevated temperatures in dope. These reactions can also proceed in precursor fiber of proper structure (meaning it needs to have at least one acidic comonomer or comonomer with active hydrogen) itself, when it is subjected to elevated temperatures. Pre-generation of such structures in dope may be more desirable in some embodiments, simply because of a more homogeneous distribution of such groups in resulting precursor fiber. Finally, such chemical groups can be also introduced into precursor polymer backbone via copolymerization of acrylonitrile with co-monomers or co-polymers bearing structural motifs of structures A, B, and C.

Monomers bearing amide group and its derivatives are well known. For example: Acrylamide, N-methyl acrylamide, N-ethyl acrylamide, N-isopropyl acrylamide, N-tert-butyl acrylamide, N-(-hydroxymethyl) acrylamide and others. Polymers having amide group and its derivatives that can be co-polymerized with acrylonitrile are also included. Acrylic monomers and polymers containing amic acid groups are included. Also included are polymers bearing imide groups with an active hydrogen that can be co-polymerized with acrylonitrile. For example, acrylic polymers with imide groups are well known and are described in U.S. Pat. Nos. 4,246,374 and 4,954,575, and in Kazantsev et al. Cellular Polymers (2021) (Vol 40 (1) pp. 31-52) and references therein.

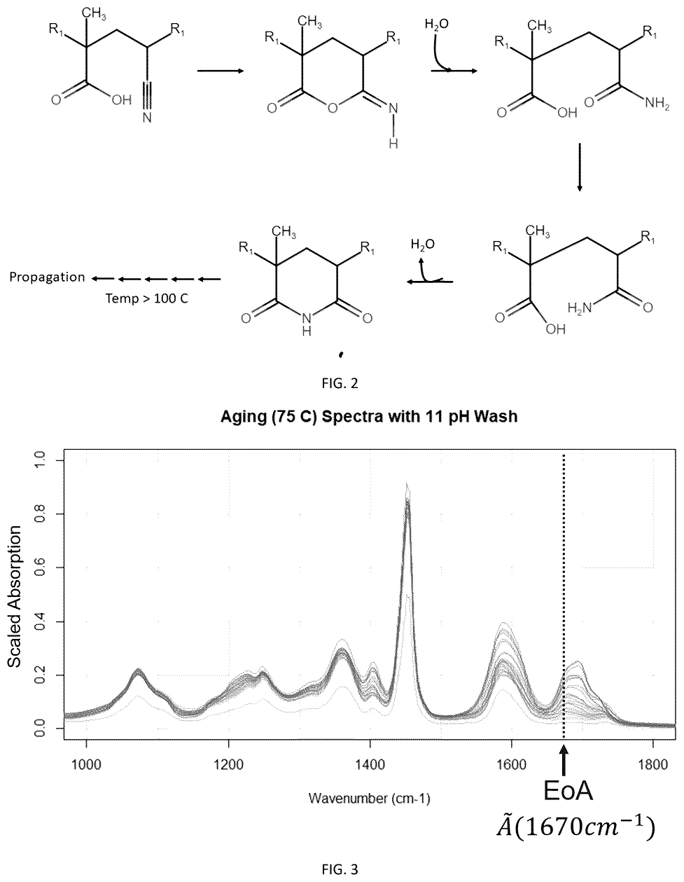

A proposed mechanism of these reactions is shown in FIG. 2. The reaction between the carboxylic acid of methacrylic acid (MAA) and an adjacent nitrile occurs readily to form an isoimide. This newly formed cyclic structure can be hydrolyzed to form a carboxylic acid/amide intermediate, which allows for free rotation of the amide. The amide can then attack the carboxylic acid to form an imide, with the release of water. Imides typically form at high temperatures (T>180° C.), but the close proximity of the groups in the polymer might favor imide formation. Subsequent unsaturated structures may also form between imide and adjacent nitriles (FIG. 1A).

The elevated temperature exposure of dopes (that leads to formation of A, B, and C) is called “dope aging” herein. Dope age is measurable via FTIR and quantifiable via a metric known as Extent of Aging (EoA). The UTS of carbon fiber is correlated with the EoA of the PAN dope from which it is formed.

It has been found that increased concentration of structures A, B, and C in PAN-based precursor fiber results in improvement of carbon fiber tensile strengths when derived from such precursor fibers. Specifically, multiple trials have shown that increasing dope age via heat or time vs control increases carbon fiber (CF) UTS up to 400 MPa.

However, it may be undesirable to have a very high concentration of structures such as described for A, B and C. The presence of such hydrophilic co-monomers and co-polymers in PAN-based carbon fiber precursor could increase the solubility in water of extruded fibers too much, and could cause processing difficulties, including during extrusion and coagulation of dopes.

Two methods were used to quantify the dope aging: FTIR and ¹H-NMR. The FTIR method allowed for obtaining an EoA value for polymer in dope from which fibers were made. The ¹H-NMR method was used to analyze precursor fibers made and to integrate N—H signals from structures A, B, and C, which were then normalized to the methylene group signal from the polymer backbone originating from acrylonitrile.

An exemplary, non-limiting method used to form, dry, and analyze the dope film is as follows:

### Dope Film Preparation

A small volume (<0.2 mL) of dope (PAN in solvent) was placed onto a glass slide using a plastic syringe. Another glass slide was placed on top of this, and pressure was applied to distribute the dope. The two slides were separated, leaving a film of dope of one side of each of the two slides. These two slides were then submerged in water, causing the PAN to coagulate. The coagulated PAN films were removed promptly from this water and then washed. The films are at this point typically approximately one to three inches in diameter.

### Washing and Drying

For all EoA (extent of aging) measurements, dope films were washed and then dried prior to FTIR measurements being taken. After films coagulated, they were rinsed with DI water for one hour. They were then placed in a container containing an aqueous solution of sodium hydroxide (NaOH) at a pH of approximately 11 (typical range of 10.5-11.5). After the dope films spent one hour in this solution, they were removed and patted dry on a paper towel. They were then left out at ambient conditions to dry on a paper towel with a small (<100 g) weight atop them for at least 2 hours (typically 18-24 hours). After this, the films were placed in aluminum dishes for transportation, and were placed in an oven at approximately 60° C. overnight (approximately 16 hours). The films were then placed in a vacuum oven at approximately 105-115° C. for 100 minutes.

### FTIR Method

For EoA, typically six films were made for each sample (three sets of slides were used). To perform FTIR, transmission mode of a Thermo Fisher Nicolet 6700 FT-IR were used. A film is placed in a sample holder and secured closed, and the sample holder is then placed in the instrument. The sample holder has an opening of approximately one centimeter; the sample was positioned such that it covered this entire opening. The sample holder was then loaded into the instrument such that the laser of the FTIR passed through the sample. One spectrum was recorded per film. For each spectrum, there were 16 scans with a resolution of 4. The Omnic software was used to collect spectra and export spectra to .txt files.

### Calculating EoA

As mentioned, for EoA, typically six films were made per sample. One FTIR transmission spectrum was collected per film. To calculate EoA for a dope sample, this transmission vs wavenumber data was exported from the FTIR software. The transmission values were converted to absorbance using the formula A=2−log₁₀(T) (the definition of absorbance). The absorbance was then scaled such that the lowest absorbance value was zero and the highest absorbance value was one. That is, the following formula was applied to each absorbance value: A_{scaled}=(A−Aₘᵢₙ)/(Aₘₐₓ−Aₘᵢₙ) where A_{scaled} is the new scaled absorbance, A is the absorbance that was calculated from Transmittance, Aₘᵢₙ is the lowest absorbance value in the spectrum, and Aₘₐₓ is the highest absorbance value in the spectrum.

For FTIR quantification, the EoA is the scaled absorbance of base-washed dope polymer film at 1670 cm⁻¹. This is depicted in FIG. 3, which shows a series of FTIR spectra of a polymer dope being aged at 75° C. Multiple experiments show that this peak increases with aging (either by time or by elevated temperature). The other peaks are accounted for in PAN structure. The two major peaks in the FTIR spectra of dope aged films are located around 1,700 cm⁻¹ and 1,680 cm⁻¹. These peaks are characteristic of the carbonyl stretching mode of a typical imide (C═O, ν=1,700 cm⁻¹) and amide (C═O, ν=1,680 cm⁻¹). The carbonyl stretching mode of the isoimide and the carboxylic acid varies between 1,730 cm⁻¹-1,710 cm⁻¹ and the imine stretching mode of the isoimide (C═N) is typically observed between 1,700 cm⁻¹-1,650 cm⁻¹. An ensemble of these structures most likely contributes to the “aging” peak/range.

The EoA was calculated for each film. For each dope, the EoAs for all films were averaged and a confidence interval calculated. Any outliers were discarded.

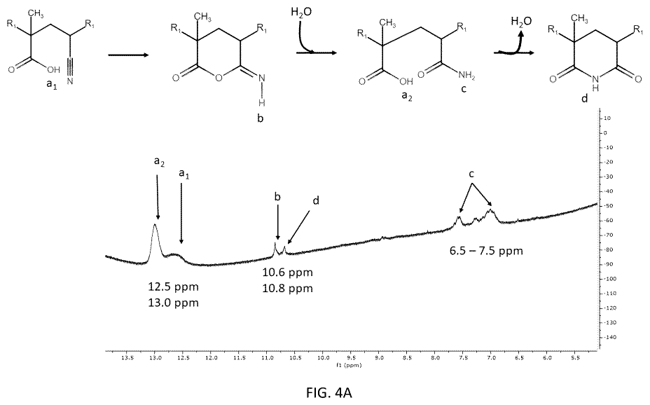

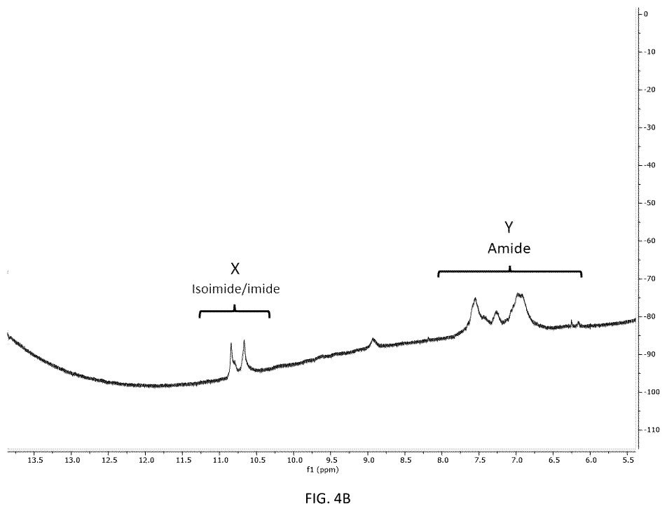

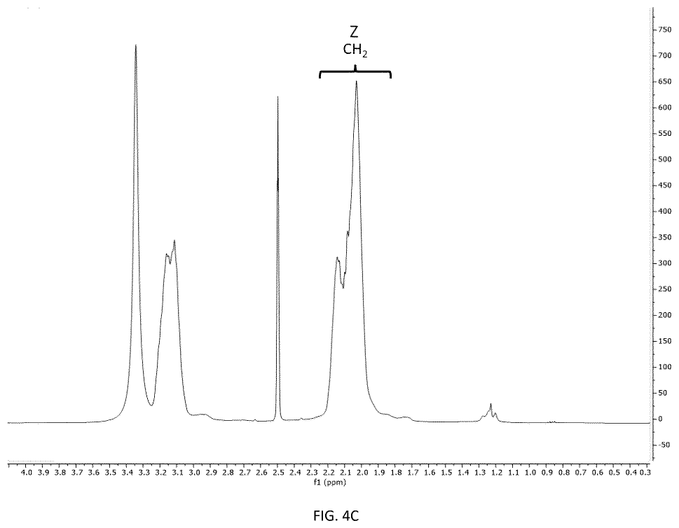

¹H-NMR data of acid washed dope aged film also provides further evidence of the formation of the structures associated with aging (FIG. 4A). The ¹H-NMR data reveals observable peaks in the downfield range of the spectrum (6.0 ppm-13.0 ppm). The two peaks denoted “a₁” and “a₂” are signals from the protons located on the carboxylic acid. Without being bound by theory, it is believed that there are two distinct peaks because one is representative of a proton not participating in hydrogen bonding while the other is participating. Hydrogen bonding should shift the proton signal downfield (13.0 ppm) relative to free carboxylic acid proton (12.5 ppm). If the carboxylic acid is in proximity to the amide (carboxylic acid/amide intermediate) then that should enhance the hydrogen bonding environment of the carboxylic acid. There can also be hydrogen bonding between two carboxylic acids in the polymer which is unrelated to the aging mechanism.

The proton located on the imine of the isoimide (C═N—H) is represented by the peak denoted “b” at 10.8, indicating that this structure is present in aged dope. This is supported by the ¹H-NMR data of model compound 1 (discussed in more detail below) which is structurally similar to the isoimide structure. In order for this structure to form, carboxylic acids and adjacent nitriles in the polymer will have to react to generate the isoimide structure. This process would be favorable at high enough temperatures. Another region of the ¹H-NMR spectrum that supports the aging mechanism is between 6.5-7.5 ppm denoted “c” which is characteristic of amide protons and unsaturated amide and amine peaks (FIG. 1A). Lastly, the proton located on the imide is hypothesized to be the peak denoted “d” located around 10.6 ppm. This is supported by the ¹H-NMR data of model compound 2 which is a structurally similar molecule to the proposed imide structure.

¹H NMR Sample Preparation

To prepare samples for analysis by ¹H NMR, fibers were first dried in a vacuum oven for at least 8 hours. The fibers were then weighed and then dissolved in deuterated dimethyl sulfoxide (DMSO) at a concentration of approximately 20-30 mg of fiber in 750 μL of deuterated DMSO. Samples were left to sit overnight with agitation until homogenous.

¹H NMR Collection

Samples were placed in NMR tubes and ¹H NMR was performed using a Varian 500 MHz NMR. ¹H NMR experiments were performed using 1024 scans, a one second relaxation delay, and a 450 pulse angle at room temperature. OpenVNMRJ software was used to collect NMR. MestReNova software was used to analyze NMR data.

¹H NMR Analysis

Imide/isoimide peaks were defined as from 11.0-10.5 ppm. Amide peaks were defined as from 8.0-6.5 ppm. Acrylonitrile CH₂ peaks were defined as from 1.83-2.25 ppm. These areas were integrated for all spectra using the MestReNova software. To calculate total aging integration ratio (TAIR), the integral (integrated peak area) of the imide/imine peaks (X) were added to the integral of the amide peaks (Y). This sum was then divided by the integral of the CH₂ peaks (Z). In short, TAIR=(imide+isoimide N—H integral+N—H amide integral)/CH₂ integral, or (X+Y)/Z. The peaks used for this calculation may be seen in the exemplary ¹H NMR spectrum shown in FIGS. 4B-4C. The present data show that TAIR as measured by ¹H NMR from fiber correlates with EoA as measured by FTIR from dope used to make that fiber. TAIR serves to quantify the structural changes and motifs introduced by the dope aging.

### Example 1—Controlling Dope EoA

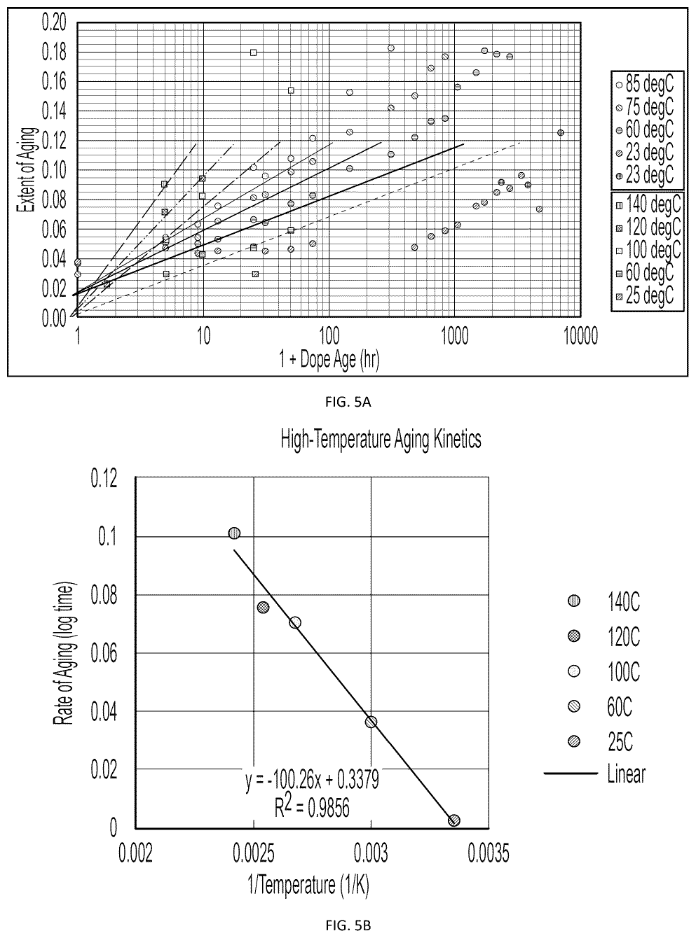

Polymer dopes were aged at varying temperatures to determine how time and temperature affected the EoA. The dope solutions comprised a copolymer made from about 98 wt % acrylonitrile and about 2 wt % MAA in aqueous NaSCN solvent. The temperature of the solutions was set to be constant, and the EoA was determined by FTIR at a series of timepoints. A plot of EoA versus aging time can be found in FIG. 5A. FIG. 5B uses this data to demonstrate the aging kinetics of the dope, plotting the rate of aging against temperature. These data demonstrate that both time and temperature can increase EoA independently, and that the aging profiles show systematic, predictable, and controllable increases in EoA.

### Example 2—Correlating EoA and UTS

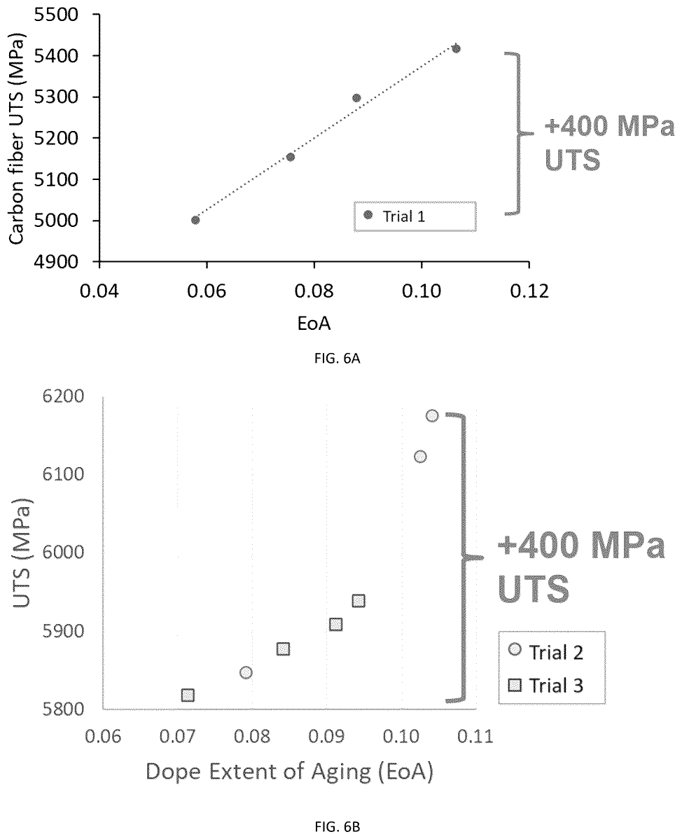

Polymer dopes were aged under both batch aging conditions and continuous aging conditions to determine the relationship between EoA and UTS of the ultimately-formed carbon fibers. For the batch aging, dopes were aged under four different conditions. Following aging, the dopes were converted into carbon fiber via a standard process. The relationship between UTS and EoA is shown in FIG. 6A. It can be seen that the UTS showed a direct relationship with EoA.

Similarly, a continuous aging process was assessed to see if a similar relationship between EoA and UTS existed. Two different trials were conducted: the second polymer dope was aged at a higher temperature, and, subsequently, had a higher EoA than the first polymer dope. The polymer dopes were subsequently converted to carbon fiber, and tested for UTS. These results are shown in FIG. 6B. It was found that increased EoA also correlated to increased UTS, and that higher temperatures allowed for shorter aging times.

### Example 3—Chemical Structure Elucidation

To further elucidate the mechanism of aging, it was determined useful to assign the ¹H-NMR (DMSO-d6) signals in polymer structure appearing with dope aging in the 10.5-11 ppm and 6.5-8 ppm regions. The 10.5-11 ppm ¹H-NMR region is normally assigned to imides, but in this case, the formation of structure A in FIG. 1B (the isoimide) was also suspected. Two model compounds were selected and obtained for testing: model compound 1 (6-imino-5,5,-dimethyloxan-2-one) (Enamine Ltd., Monmouth Jct., NJ) and model compound 2 (3,3-dimethylpiperidine-2,6-dione, an imide) (AstaTech Inc., Bristol, PA):

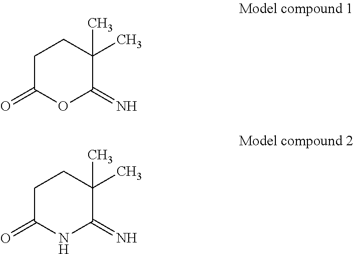

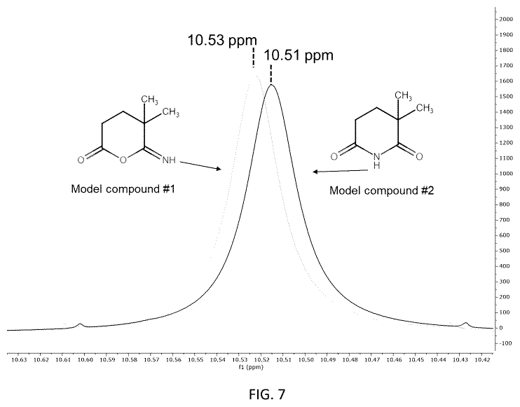

These structures are almost identical to the structures suspected of being formed. These two model compound structures—particularly their N—H signal locations—were investigated by ¹H-NMR in DMSO-d6. Both N—H signals were found to be in the 11.0-10.5 region (FIG. 7), but were too close to be assigned unequivocally in fiber NMRs. Specifically, model compound #1 exhibits two distinct peaks located at 2.5 ppm and 10.53 ppm, where the 10.53 ppm is the proton on the nitrogen. The peak from model compound 2 also falls within the region of 10 ppm-11 ppm (10.50 ppm).

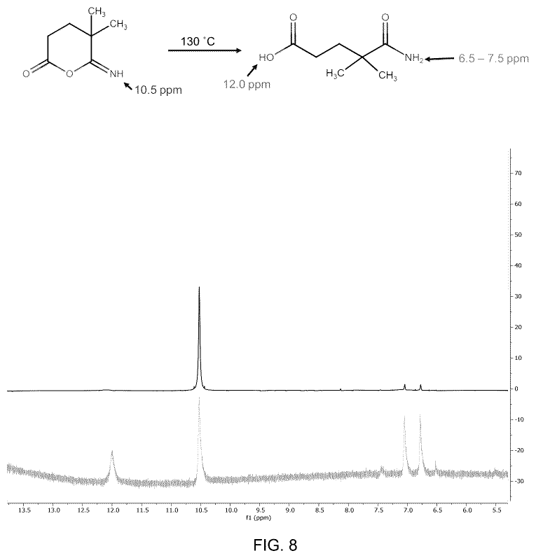

The 8-6.50 ppm region is most commonly assigned to amides. Moreover, it was shown in a DSC experiment that structure A is not particularly temperature stable, and can quickly generate amide structure C via ring opening hydrolysis at 130° C., as was confirmed by ¹H-NMR analysis (FIG. 8). Note that model compound 1 as obtained, prior to exposure to heat, already appears to have traces of amide impurity.

Because that region looks quite complex, without being bound by theory, it is believed that that there are more structures than just a simple amide C contributing to these signals. As with more aging this area becomes quite complex, it is believed that N—H groups from unsaturated structures depicted in FIG. 1B contribute to this region of the spectrum. Such structures are commonly believed to form at the initial stages of ladder formation when PAN copolymers are subjected to oxidative conditions between 200-300° C. during the initial stages of carbon fiber manufacturing and sometimes at even lower temperatures.

### Example 4—Solvent and Base Effects

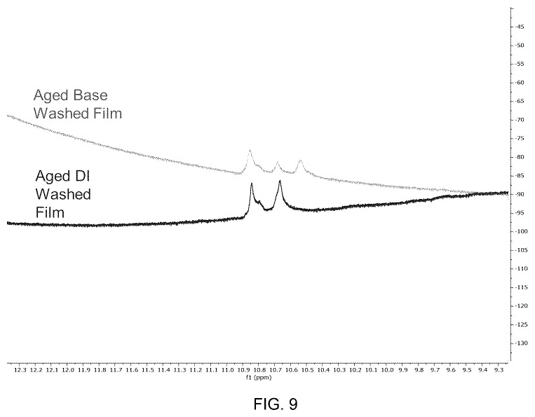

Additional information can be found in NMR spectra of polymer from aged dope films. In this case, one film was treated with dilute base (sodium hydroxide) and the other one was not. What was observed was a splitting of one of the peaks situated at lower ppms into two peaks in a sample that was treated with dilute base (FIG. 9). Out of the two structures being observed (Structures A and B in FIG. 1) only the imide proton is slightly acidic, and therefore susceptible to interaction with base. The splitting was observed because the base did not penetrate very well into the film to interact with all available imide protons, so some original signal is still observed. The peak present at 10.7 ppm was therefore assigned to that of imide N—H structure B. The more downfield peak, at 10.9 ppm, is assigned to isoimide structure A. That peak always has a shoulder, which is believed to be due to the interaction of the N—H proton with different polymer chain environments.

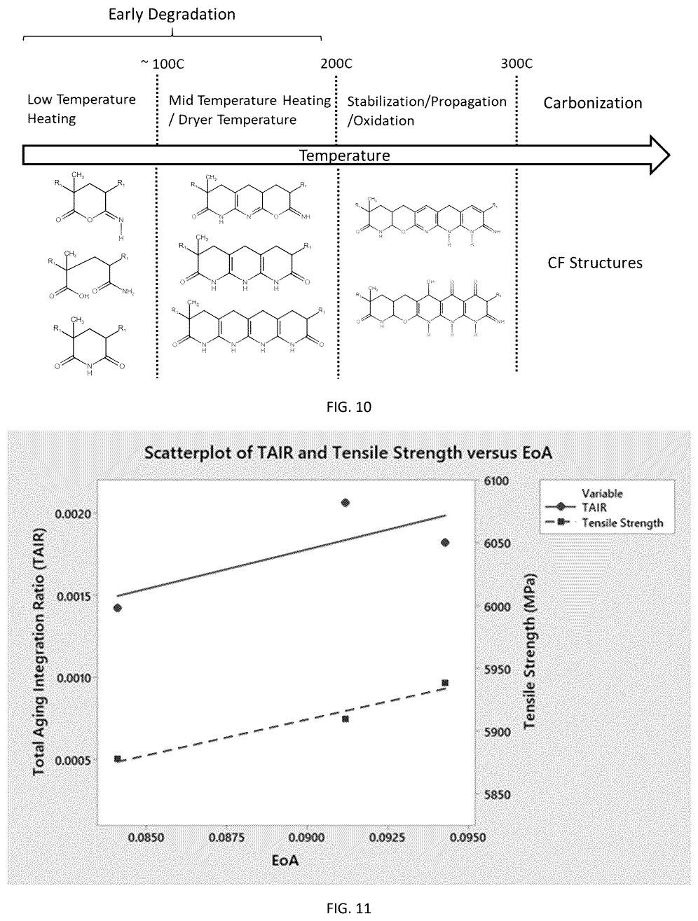

Based on the above analysis, a summary of the different processes/structures believed to occur/form in PAN polymer under different heating conditions is shown in FIG. 10. Under low heat, the structures predominately formed include the isoimide, carboxylic acid/amide, and the imide. Further heating further results in slow propagation of cyclization via the oxygen atom, leading to conjugated structures that are imine/enamine in character. It is believed that these conjugated structures are responsible for the initial yellow coloring of the PAN polymer under mid temperature heating. At temperatures>200° C., propagation occurs which results in cyclization of the nitriles, dehydrogenation of the backbone, and oxidation of the rings. These structures are necessary for the subsequent very high temperature carbonization process which leads to typical carbon fiber structures.

### Example 5—Correlation of Aging Process to Increases in EoA, UTI, and TAIR

The polyacrylonitrile (PAN) precursor fibers used in this Example were prepared as follows. The fibers were made from a copolymer comprising about 98 wt % acrylonitrile and about 2 wt % methacrylic acid by air gap wet spinning. A single tow pilot spinning line was employed. The spinning and coagulant solutions were based on an aqueous sodium thiocyanate. The fibers were stretched during spinning compared to their length after extrusion from the spinnerets.

The precursor fibers were bundled in tows of 6,000 (6K) filaments per tow, with filament deniers of 0.8. The tows were then passed through a finishing step and dried on dryer rolls.

For each of Fibers 1-3, spools of 6K precursor fibers were converted into carbon fibers by Hexcel proprietary procedure on a Production carbon fiber line. The resulting fiber tows were surface treated and sized with Hexcel's proprietary GS-size. The amount of the size on all fibers was 0.5 wt. %. The fibers were than subjected to tensile testing to determine UTS. The testing protocol was ASTM D-4018.

Fiber 1: The dope from which Fiber 1 was spun was subjected to the following temperature/time exposure: Freshly made dope was heated to 135° C. and flowed through a continuous mixing tank at 96° C. Average residence time in the mixing tank was 27 hours.

A sample of dope from which the fiber was spun was collected and a thin polymer film was made from this dope and analyzed by FTIR to establish EoA. An EoA of 0.0841 was found. The resulting precursor fiber sample was analyzed by ¹H-NMR in DMSO-d6 and integrated and normalized signals from areas X (imide/isoimide), Y (amide) and Z (CH₂) are reported as TAIR (Total Aging Integration Ratio) in FIG. 11. TAIR was equal to 0.0014.

The resulting spun precursor fiber was carbonized as described above and UTS of 5877.8 MPa is reported in FIG. 11.

Fiber 2: The dope from which Fiber 2 was spun was subjected to the following temperature/time exposure: Freshly made dope was heated to 140° C. and flowed through a continuous mixing tank at 98° C. Average residence time in the mixing tank was 27 hours.

A sample of dope from which the fiber was spun was collected and a thin polymer film was made from this dope and analyzed by FTIR to establish EoA. An EoA of 0.0912 was found. The resulting precursor fiber sample was analyzed by ¹H-NMR in DMSO-d6 and integrated and normalized signals from areas X, Y, and Z are reported as TAIR in FIG. 11. TAIR was equal to 0.0021.

The resulting spun precursor fiber was carbonized as described above and UTS of 5909.6 MPa is reported in FIG. 11.

Fiber 3: The dope from which Fiber 3 was spun was subjected to the following temperature/time exposure: Freshly made dope was heated to 130° C. and flowed through a continuous mixing tank at 89° C. Average residence time in the mixing tank was 27 hours. This was blended with a small fraction of residual dope aged seven months at ambient temperature.

A sample of dope from which the fiber was spun was collected. A thin polymer film was made from this dope and analyzed by FTIR to establish EoA. An EoA of 0.0943 was found. The resulting precursor fiber sample was analyzed by ¹H-NMR in DMSO-d6 and integrated and normalized signals from areas X, Y, and Z are reported as TAIR in FIG. 11. TAIR was equal to 0.0018.

The resulting spun precursor fiber was carbonized as described above and UTS of 5939.0 MPa is reported in FIG. 11.

### Example 6—Correlation of Aging Process to Increases in EoA, UTI, and TAIR

The polyacrylonitrile (PAN) precursor fibers used in this Example were prepared as follows. The fibers were made from a copolymer comprising about 98 wt % acrylonitrile and about 2 wt % methacrylic acid by air gap wet spinning. A single tow pilot spinning line was employed. The spinning and coagulant solutions were based on an aqueous sodium thiocyanate. The fibers were stretched during spinning compared to their length after extrusion from the spinnerets.

The precursor fibers were bundled in tows of 6,000 (6K) filaments per tow, with filament deniers of 0.6. The tows were then passed through a finishing step and dried on dryer rolls.

For each of Fibers 1-3, spools of 6K precursor fibers were converted into carbon fibers by Hexcel proprietary procedure on a Pilot carbon fiber line. The resulting fiber tows were surface treated and sized with Hexcel's proprietary GP-size. The amount of the size on all fibers was 0.9 wt. %. The fibers were then subjected to tensile testing to determine UTS. The testing protocol was ASTM D-4018.

Fiber 1: The dope from which Fiber 1 was spun was subjected to the following temperature/time exposure: Freshly made dope was heated to 77° C. and flowed through a continuous mixing tank at 79° C. Average residence time in the mixing tank was 38 hours.

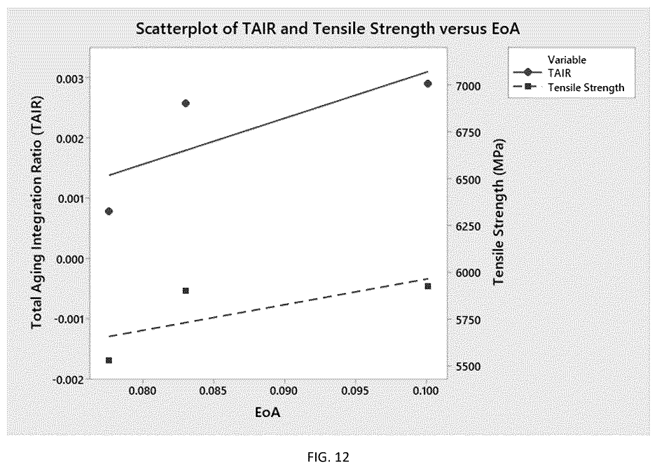

A sample of dope from which the fiber was spun was collected and a thin polymer film was made from this dope and analyzed by FTIR to establish EoA. An EoA of 0.0776 was found. The resulting precursor fiber sample was analyzed by ¹H-NMR in DMSO-d6 and integrated and normalized signals from areas X (imide/isoimide), Y (amide) and Z (CH₂) are reported as TAIR (Total Aging Integration Ratio) in FIG. 12. TAIR was equal to 0.0008.

The resulting spun precursor fiber was carbonized as described above and UTS of 5531 MPa is reported in FIG. 12.

Fiber 2: The dope from which Fiber 2 was spun was subjected to the following temperature/time exposure: Freshly made dope was heated to 109° C. and flowed through a continuous mixing tank at 91° C. Average residence time in the mixing tank was 38 hours.

A sample of dope from which the fiber was spun was collected and a thin polymer film was made from this dope and analyzed by FTIR to establish EoA. An EoA of 0.0830 was found. The resulting precursor fiber sample was analyzed by ¹H-NMR in DMSO-d6 and integrated and normalized signals from areas X, Y, and Z are reported as TAIR in FIG. 12. TAIR was equal to 0.0026.

The resulting spun precursor fiber was carbonized as described above and UTS of 5904 MPa is reported in FIG. 12.

Fiber 3: The dope from which Fiber 3 was spun was subjected to the following temperature/time exposure: Freshly made dope was heated to 150° C. and flowed through a continuous mixing tank at 102° C. Average residence time in the mixing tank was 38 hours.

A sample of dope from which the fiber was spun was collected. A thin polymer film was made from this dope and analyzed by FTIR to establish EoA. An EoA of 0.1001 was found. The resulting precursor fiber sample was analyzed by ¹H-NMR in DMSO-d6 and integrated and normalized signals from areas X, Y, and Z are reported as TAIR in FIG. 12. TAIR was equal to 0.0029.

The resulting spun precursor fiber was carbonized as described above and UTS of 5927 MPa is reported in FIG. 12.

Many modifications and other embodiments of the invention set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A polyacrylonitrile (PAN)-based precursor carbon fiber, said precursor carbon fiber having a total aging integration ratio (TAIR) of from about 0.0005 to about 0.1000, wherein TAIR is equal to
(X+Y)/Z
wherein X is the integrated peak area in a range of 11.0-10.5 ppm, Y is the integrated peak area in a range of 8.0-6.5 ppm, and Z is the integrated peak area in a range of 1.83-2.25 ppm, according to ¹H-NMR in deuterated DMSO.

2. The PAN-based precursor carbon fiber of claim 1, prepared from a copolymer formed from a composition comprising
i) acrylonitrile monomers; and
ii) acidic comonomers comprising an active hydrogen.

3. The PAN-based precursor carbon fiber of claim 2, wherein said composition comprises i) in an amount of 80-99.9 wt %; and ii) in an amount of 0.1-20 wt %.

4. The PAN-based precursor carbon fiber of claim 2, wherein the acidic comonomer comprising an active hydrogen is selected from the group consisting of methacrylic acid, acrylic acid, itaconic acid, and combinations thereof.

5. The PAN-based precursor carbon fiber of claim 4, wherein the acidic comonomer comprising an active hydrogen is methacrylic acid.

6. The PAN-based precursor carbon fiber of claim 2, wherein the composition further comprises iii) at least one monomer or polymer comprising an amide, imide or isoimide functional group, wherein said functional group comprises an active hydrogen.

7. The PAN-based precursor carbon fiber of claim 6, wherein the composition comprises iii) in an amount of 0.1-15 wt %.

8. The PAN-based precursor carbon fiber of claim 1, prepared from a copolymer comprising
i) a plurality of units derived from acrylonitrile; and
ii) at least one unit selected from the group consisting of 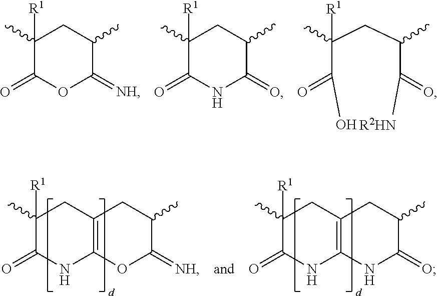
wherein R¹ is —CH₃, —CH₂COOH, or —H;
wherein R² is C₁₋₆ alkyl or —H;
wherein d is 1-1000; and
wherein each [symbol] represents a point of attachment to the remainder of the copolymer.

9. The PAN-based precursor carbon fiber of claim 8, wherein the molar ratio of i) to ii) is from 99.9:0.1 to 80:20.

10. The PAN-based precursor carbon fiber of claim 2, wherein the copolymer is not water soluble at 25° C.

11. The PAN-based precursor carbon fiber of claim 1, wherein the TAIR is at least about 0.0006, 0.0007, 0.0008, 0.0009, 0.0010, 0.0011, 0.0012, 0.0013, 0.0014, 0.0015, 0.0016, 0.0017, 0.0018, 0.0019, 0.0020, 0.0021, 0.0022, 0.0023, 0.0024, 0.0025, 0.0026, 0.0027, 0.0028, 0.0029, 0.0030, 0.0031, 0.0032, 0.0033, 0.0034, 0.0035, 0.0036, 0.0037, 0.0038, 0.0039, 0.0040, 0.0041, 0.0042, 0.0043, 0.0044, 0.0045, 0.0046, 0.0047, 0.0048, 0.0049, 0.0050, 0.0055, 0.0060, 0.0065, 0.0070, 0.0075, 0.0080, 0.0085, 0.0090, 0.0095, 0.0100, 0.0150, 0.0200, 0.0250, 0.0300, 0.0350, 0.0400, 0.0450, 0.0500, 0.0550, 0.0600, 0.0650, 0.0700, 0.0750, 0.0800, 0.0850, 0.0900, or 0.0950.

12. The PAN-based precursor carbon fiber of claim 1, wherein the TAIR is at most about 0.0050, 0.0055, 0.0060, 0.0065, 0.0070, 0.0075, 0.0080, 0.0085, 0.0090, 0.0095, 0.0100, 0.0150, 0.0200, 0.0250, 0.0300, 0.0350, 0.0400, 0.0450, 0.0500, 0.0550, 0.0600, 0.0650, 0.0700, 0.0750, 0.0800, 0.0850, 0.0900, or 0.0950

13. A carbon fiber prepared from the PAN-based precursor carbon fiber of claim 1, wherein the prepared carbon fiber has an ultimate tensile strength (UTS) of greater than about 5500 MPa.

14. The carbon fiber of claim 12, wherein the UTS is greater than about 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, or 8000.

15. A fiber-reinforced composite laminate comprising the carbon fiber of claim 13.
